(19) United States
(12) Patent Application Publication
(10) Pub. No.: US 2026/0154735 A1
(43) Pub. Date: Jun. 4, 2026

(54) Systems and Methods for Maintaining Sub Account Integrity

(71) Applicant: The PNC Financial Services Group, Inc., Pittsburgh, PA (US)

(72) Inventor: Bryan MACKRELL, Pittsburgh, PA (US)

(21) Appl. No.: 19/262,357

(22) Filed: Jul. 8, 2025

Related U.S. Application Data
(60) Provisional application No. 63/669,509, filed on Jul. 10, 2024.

(51) Int. Cl. G06Q 40/02

(52) U.S. Cl. CPC G06Q 40/0221

(57) ABSTRACT

Systems and methods are provided for a banking system that permits automatic generation of a second financial account using the account holder information associated with the first financial account. Account holders to reserve funds for future bill payments in a second financial account. The account holders may submit a bill reservation request that identifies a scheduled bill event with an associated bill amount to be paid from a first financial account via a payment processor. After receipt of the bill reservation request from the account holder, the banking system transfers funds equal to the bill amount identified in the bill reservation request from the first financial account to the second financial account. The banking system also instructs the payment processor to withdraw the bill amount identified in the bill reservation request from the second financial account instead of the first financial account. In this manner, an account holder may seamlessly reserve a portion of the first financial account for an upcoming bill in a manner that the account holder is prevented from accessing the reserved funds ahead of the bill payment.

### CROSS-REFERENCE TO RELATED APPLICATIONS

The present application claims priority to U.S. Provisional Application No. 63/669,509, filed Jul. 10, 2024, which is incorporated herein by reference in its entirety.

### BACKGROUND

Accounts at financial institutions, such as a checking account at a bank, function as fundamental tools for managing finances, offering individuals and organizations a secure place to deposit their money while providing convenient access to funds for everyday transactions. When an entity opens a financial account with a bank or credit union, they deposit money into the account, which the financial institution holds on their behalf. These funds can then be accessed through various means, including checks, debit cards, and electronic payment transfers. When an entity writes a check or makes a purchase using their debit card, the funds are deducted from their checking account balance. Similarly, when bills need to be paid, entities can use their checking accounts to set up automatic payments or initiate one-time electronic transfers, providing a hassle-free way to manage recurring expenses such as utilities, rent, or loan payments.

Opening a financial account can be a cumbersome process for both the account holder and the bank due to various factors. For the account holder, the process often involves gathering and providing extensive documentation, such as identification, proof of address, and sometimes even references. Additionally, banks may require applicants to meet certain eligibility criteria, such as credit checks or minimum deposit requirements, which can further complicate the process. For the bank, verifying the provided information and conducting necessary checks to comply with regulatory requirements can be time-consuming and resource-intensive. Furthermore, ensuring the security of the account and mitigating the risk of fraud or identity theft adds another layer of complexity to the process.

Moreover, many banks and credit unions offer online and mobile banking platforms that further streamline bill payment processes. Through these platforms, entities can conveniently view their account balances, track transactions, and schedule bill payments from the comfort of their own homes or on the go. Some financial institutions also provide features like bill pay services, where entities can electronically send payments to designated recipients directly from their checking accounts, eliminating the need for writing and mailing physical checks. Accordingly, checking accounts play a crucial role in enabling entities to efficiently manage their finances and pay bills in a timely manner.

### SUMMARY

In view of the foregoing, systems and methods are provided herein that allow financial institutions to create, maintain, and retire limited-purpose secondary financial accounts, such as sub accounts, that may be associated with one or more primary accounts. Such secondary financial accounts may rely on entity information associated with the associated primary account to avoid the cumbersome account creation process associated with traditional accounts, and may be facilitated by the financial institution using the techniques described herein. These secondary accounts may provide advantages to both entities and financial institutions by, for example, reserving funds for specific future use.

As one example of a process that is enabled through the use of secondary financial accounts using the systems and methods described herein, account holders may reserve funds for future bill payment in a secondary financial account (e.g., sub account) which is separate from the primary financial account (e.g., checking account). In this way, account holders may instruct their financial institution to reserve funds from their primary account for an upcoming bill or savings goal. Rather than simply identifying these funds as being intended for the upcoming bill, the techniques describe herein rely on the creation and facilitation of secondary accounts to actually transfer funds equal to the bill amount out of the primary account (e.g., checking account). Thus, the account holder may be prevented from inadvertently transferring or spending the reserved funds prior to the bill payment date, since the funds are no longer held within the primary financial account. In this manner, the systems may help to ensure that the account holder will have sufficient funds to pay their future bills on the scheduled payment date. For instance, the banking system may automatically and seamlessly instruct the payment processor to pay the bill amount from the second financial account (e.g., bill pay sub account) instead of the first financial account. Also provided herein are techniques associated with displaying the information relating to the account statuses of the primary and secondary financial accounts, such that an account holder may easily discern the funds available to be spent and the funds that have been reserved in a secondary financial account.

In one aspect, the present disclosure provides a banking system that may include one or more processors coupled to at least one data store that stores instructions, which when loaded into at least one memory cause the one or more processors to perform various operations. The operations may include receiving a request from an account holder for the creation of a sub account associated with a first financial account; accessing a data store housing the first financial account to retrieve information associated with the account holder; automatically generating a sub account using the account holder information associated with the first financial account, the sub account including a unique account number and being capable of receiving and transferring funds; and transferring funds from the first financial account to the sub account.

In another aspect, the present disclosure provides a banking system that may include one or more processors coupled to at least one data store storing instructions, which when loaded into at least one memory cause the one or more processors to perform various operations. The operations may include receiving a bill reservation request associated with a first financial account, the bill reservation request identifying a scheduled bill event that includes a bill amount to be paid from the first financial account via a payment processor. The operations may also include transferring funds equal to the bill amount identified in the bill reservation request from the first financial account to a second financial account, and instructing the payment processor to transfer the bill amount identified in the bill reservation request from the second financial account instead of the first financial account.

In one aspect, the present disclosure provides a computer-assisted method for generating a graphical representation of financial accounts that are administered by an entity. The method may include obtaining, using a processor, data relating to the account balances of a first financial account and a second financial account, the second financial account being a sub account of the first financial account and being configured to receive funds reserved for bill payment. The method may also include generating for display, using the processor, a graphical user interface that includes a visual indicator having a first element corresponding to the account balance of the first financial account and a second element corresponding to the account balance of the second financial account, wherein the proportion of the area of the first element to the second element is determined based on the account balances of the first and second financial accounts.

In yet another aspect, the present disclosure provides a system for reserving funds in a financial account for future bill payment. The system may include means for receiving a request from an account holder for the creation of a sub account associated with a first financial account as well as means for accessing a data store housing the first financial account to retrieve information associated with the account holder. The system may additionally include means for automatically generating a sub account using the account holder information associated with the first financial account, the sub account including a unique account number and being capable of receiving and transferring funds. Further still, the system may include means for transferring funds from the first financial account to the sub account.

The details of one or more variations of the subject matter described herein are set forth in the accompanying drawings and the description below. Other features and advantages of the subject matter described herein will be apparent from the description and drawings, and from the claims.

### BRIEF DESCRIPTION OF DRAWINGS

FIG. 1 is a diagram depicting the creation of a secondary financial account associated with a primary financial account.

FIG. 2 is a diagram depicting communication channels associated with various entities involved in a reserve for bill pay process.

FIG. 3 is a diagram depicting a system facilitating a bill payment from a secondary financial account.

FIG. 4 is a diagram depicting a funds transfer workflow associated with a reserve for bill pay process.

FIG. 5 is a diagram depicting a timeline representation of a reserve for bill pay process, including some of the customer experiences, visual representations, and backstage banking system actions that may be performed at each stage in the process.

FIG. 6A is a diagram depicting a graphical user interface, including a first part of a schedule bill prompt, which may be provided to a user device as part of a reserve for bill pay process.

FIG. 6B is a diagram depicting a graphical user interface, including a second part of a schedule bill prompt, which may be provided to a user device as part of a reserve for bill pay process.

FIG. 6C is a diagram depicting a graphical user interface, including a visual indicator having a bar corresponding to the account balance of a checking account and a second bar section corresponding to the account balance of a sub account of the checking account.

FIG. 7 is a diagram depicting a graphical user interface, including a visual indicator having a bar with sections corresponding to the account balance of a checking account (“Scheduled Out” and “Free Balance”) and a sub account (“Reserved for Bill Pay”) of the checking account.

FIG. 8 is a flowchart of a method for reserving funds for future payment.

FIG. 9 is a flowchart of a method for generating a graphical representation of financial accounts that are administered by an entity.

FIG. 10 depicts an example hardware system for implementing the approaches described herein.

The current subject matter will be better understood by reference to the following detailed description when considered in combination with the accompanying drawings which form part of the present specification.

### DETAILED DESCRIPTION

The following disclosure provides many different aspects, or examples, for implementing different features of the provided subject matter. Specific examples of components and arrangements are described below to simplify the present disclosure. These are, of course, merely examples and are not intended to be limiting.

As discuss above, financial institutions typically associate one pool of funds per financial account (e.g., checking account), where money freely flows into and out of that primary financial account on demand, as that entity spends, transfers, and receives funds. One drawback of this arrangement, is that such accounts are susceptible to overdrafts. An overdraft occurs when a bank account holder withdraws or spends more money than is available in their account, resulting in a negative balance. Moreover, when money is coming into and out of an account in an automated fashion (e.g., auto-bill pay), the risk of overdrawing an account increases. And if there are insufficient funds within the entity's account on the payment date, the scheduled payment may not be completed and/or the financial institution may have to temporarily lend the user the money, leading to the user receiving an overdraft charge. While budgeting visualizations may be provided to assist account holders in avoiding such overdraws, these aids still require frequent attention from account holders, and therefore unexpected occurrences or monitoring lapses can still result in an account overdraw.

As detailed herein, the systems and methods of the present disclosure may facilitate the on-demand account provisioning, tracking, and retirement of secondary financial accounts associated with a first financial account. Accordingly, these techniques may provide users with the option to easily set aside the necessary funds for an upcoming bill payment in a separate financial account in order to prevent the user from inadvertently spending these funds prior to the payment date. In this manner, the scheduled funds may be “saved for later” and no longer accessible in the primary account. Without the separation of funds between the two accounts, a user may unknowingly spend funds that they would otherwise wish to save for future bill payment. The financial institution may seamlessly take action to ensure that the bill payment is scheduled out of the financial account to which the funds have been transferred. Furthermore, the user may be advised of the status of each of these accounts through a graphical user interface that may inform them of relevant information during the reserve for bill pay process described herein, such as the account balances, the number of upcoming payments, and the payment dates.

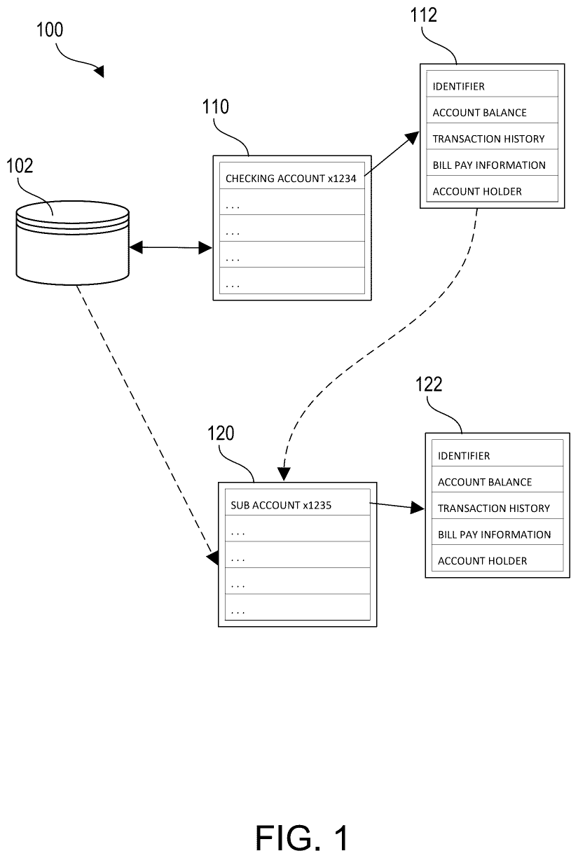

FIG. 1 depicts a system 100 in which a data structure of a secondary financial account 120 is generated using information 112 stored within a data structure of a primary financial account 110. As shown, a database 102 may store multiple primary accounts 110 that each include associated information 112 with said accounts, including but not limited to, account identifiers (e.g., routing numbers), account balance information, transaction histories, bill pay information (e.g., future payment dates, amounts, and associated transfer information), and information about the account holder (e.g., legal name, address, social security number, etc.). Based on the request of the user or a system request, one or more processors may interact with the database 102 to create of a sub account 120 associated with the first financial account 110. In particular, in order to reduce the inefficiencies associated with account creation, the sub account may be created using the information 112 associated with the first financial account 110, such as account holder information that is stored as part of the first financial account 110. This data may be retrieved and used to automatically generate the sub account 120, which may include its own associated account information 122, such as a unique account number and may be capable of receiving and transferring funds. As part of this account creation process, or at a later period in time, funds may be transferred from the first financial account 110 to the sub account 120. The system may facilitate this transfer by, for example, updating the transaction histories and the account balances associated with each account. As will be further described, the funds transferred may be intended for a specific future transaction. The system may be configured to automatically retire (i.e., delete) the sub account 120 after a specific function for which the sub account 120 was created has been realized. For example, the sub account 120 may be automatically retired after funds are subsequently transferred out of the sub account 120, such as for a bill payment. Retirement of the sub account 120 may include removal of the account number and associated information from the database 102.

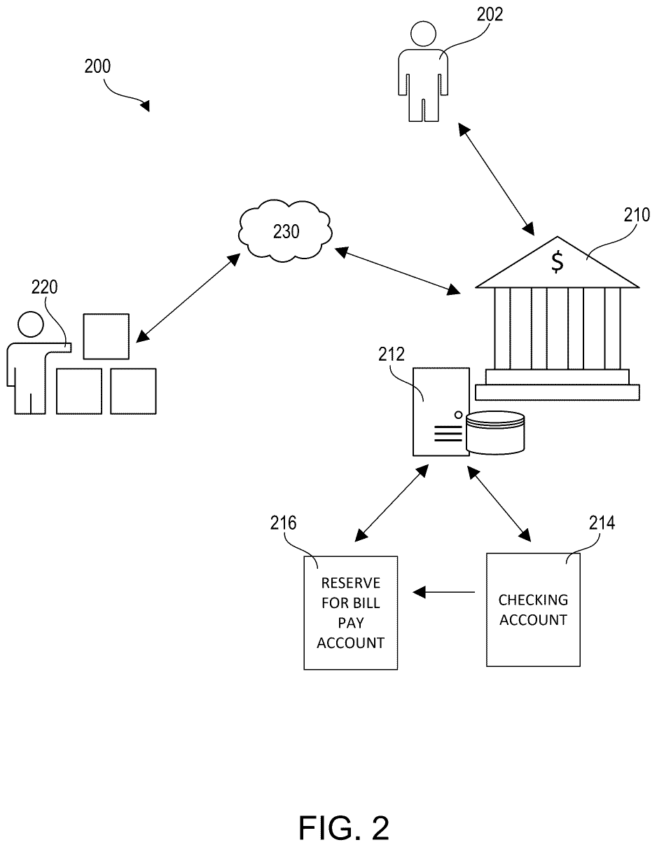

FIG. 2 depicts communication channels associated with various entities 200 involved in a reserve for bill pay process that may rely on the account creation, facilitation, and retirement techniques described herein. In general, a user 202 may be a customer of a financial institution 210 (e.g., bank), and may have various accounts associated with the financial institution 210, including a checking account 214. These financial accounts may be stored using the core banking system 212 of the financial institution 210, which may rely on processors, databases, and other computing elements to enable the functionality of the bank, including, for example, storing account information, coordinating transactions, and providing information to customers of the financial institution 210, such as the user 202. Also depicted within FIG. 2 is a merchant 220 (e.g., electric company) and a payment processor 230. In general, the merchant 220 may interact with the financial institution 210 through the processor 230, and may also directly interact with the user 202, such as by selling goods or providing services to the user 202.

During the reserve for bill pay processes described herein, the merchant 220 may issue a bill to the user 202 for a good or service previously provided (e.g., electric bill, student loan payment, etc.). At this time, the user 202 may then choose to schedule a bill payment by providing information about the merchant 220 to the financial institution 210 and or the payment processor 230. Alternatively, if the user 202 had previously added personal information and/or information about the merchant to their bill pay service, they may receive a notification from the payment processor 230 and/or the financial institution 210 notifying them of the issued bill and prompting them to schedule a bill payment.

As discussed above, financial institutions may offer bill pay services, where entities can electronically send payments to designated recipients directly from their financial accounts. In order to facilitate this service, the financial institution may work with a third party payment processor (e.g., Fiserv Bill Pay), or may facilitate this service using their own payment systems. Generally, users may first need to enroll in the bill pay service through their financial institution's online or mobile banking platform, which may involve providing some personal information and setting up payment accounts. Once enrolled, users may then add the companies or individuals (utilities, credit cards, loans, and other bills) that they would like to schedule payments to. This may require users to provide the payee's information, such as name, address, and account and routing numbers. After adding payees, users can schedule one-time or recurring payments. The users may specifically choose the payment amount and the date they want the payment to be sent. Recurring payments can be set up for bills that are due regularly, such as monthly rent or loan payments. The payment processor may also work directly with merchants issuing bills to connect with users that have enrolled in the bill pay service, such as by providing the bills directly to the users through the bill pay service at the request of the merchant. On the scheduled payment date, the payment processor may then transfer the funds from the user's account and send the payment to the payee.

As part of scheduling the bill payment, or subsequently thereafter, the user 202 may be permitted to submit a bill reservation request to the financial institution 210. The bill reservation request may instruct the financial institution 210 to set aside the funds for the scheduled bill payment into a separate account. As will be further discussed, the core banking system 212 may then transfer the necessary funds from the checking account 214 to a reserve for bill pay account 216. Once the funds are in the reserve for bill pay account 216, the user 202 may no longer be able to access them by writing checks or using debit cards associated with the checking account 214. The financial institution 210 may communicate with the payment processor 230 to ensure that the bill funds are taken from the reserve for bill pay account 216, not the checking account 214. This communication may involve providing identifier information (e.g., an account number) associated with the reserve for bill pay account 216. On the payment date, the payment processor 230 may coordinate the transfer of the payment funds from the reserve for bill pay account 216 to the merchant 220.

Although the present disclosure often describes the process of reserving the funds in a separate accounts with respect to scheduled bill payments, it should also be appreciated that the techniques described herein may be applied to future savings goals and other financial actions that require future money transfers or goals. For instance, if a user wishes to transfer a predefined amount of money into a retirement account on specific dates throughout the year (e.g., quarterly), the techniques described herein for relying on a secondary financial account to reserve those funds may be used to ensure that such a savings goals is met. Alternatively, the secondary account may itself function as a savings account, to assist a user in achieving savings goals.

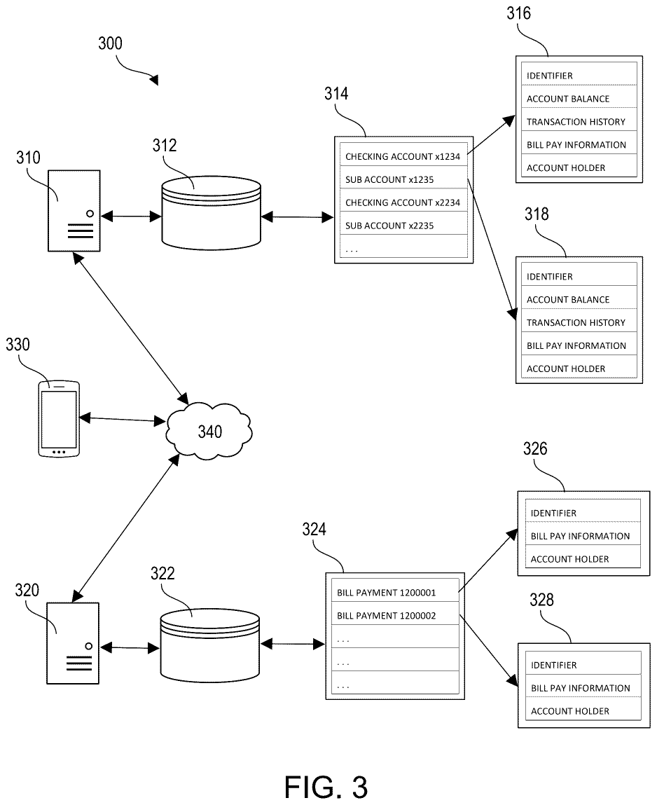

FIG. 3 depicts a system 300 facilitating the reassignment of a bill payment from a primary checking account 316 to a secondary sub account 318. As shown, a database 312 of a financial institution may store information associated with various financial accounts 314, including the primary checking account 316 and the associated sub account 318. An account holder may submit a bill reservation request using, for example, personal device 330, which may be in communication with one more databases 312 and processing units 310 of the financial institution via a network 340. When an account holder submits a bill reservation request, funds may be transferred from the primary checking account 316 to the secondary sub account 318 and the respective transaction histories of each account may be updated in the database 312 using the processor 310. Moreover, a payment processor may be instructed to collect the payment from the sub account 318. This instruction may be done automatically by providing information to the payment processor, such as at least one identifier associated with the sub account 318 (e.g., account number) and information identifying the scheduled payment (e.g., a payment identifier). A processing unit 320 of the payment processor may receive this instruction and update its records to reflect the new account associated with the bill payment. This may include rewriting information associated with one or more bill payments 326, 328 stored as part of a future bill payment group 324 on one or more databases 322 on the payment processor's system. With the records now updated, the payment processor may then communicate with the financial system via the banking network, or a separate payment network, to receive the funds on the scheduled bill payment date, with the financial system updating the account information in the sub account 318 on said payment date.

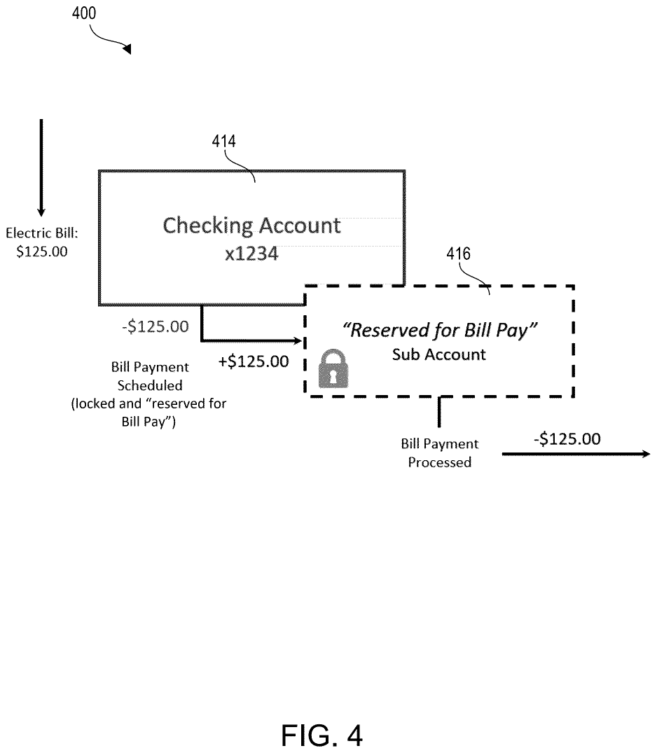

FIG. 4 depicts a funds transfer workflow 400 associated with a reserve for bill pay process that uses an example electric bill of $125.00. After a bill reservation request is received along with a scheduled bill payment, funds equal to the amount of the bill are transferred from the checking account 414 to a “reserved for bill pay” sub account 416, where they are then held until the bill payment date. Again, during this time, a payment processor or an internal payment service of the financial institution may be instructed to obtain the bill amount identified in the bill reservation request from the sub account 416, instead of the checking account 414. This instruction may include providing an identifier associated with the sub account 416 to the payment processor or the internal payment service in order to update the account from which the funds will be drawn. On the bill payment date, the $125.00 worth of funds is then transferred out of the sub account 416 to the bill issuer.

As shown in the example workflow of FIG. 4, the first financial account may be separate and distinct from the second financial account. For instance, a checking transaction or withdrawal associated with the first financial account may not be able to directly access funds held within the second financial account. The second financial account may have its own account number in order to facilitate the scheduled payments. Rather than operating as a second checking account, the second financial account may be a sub account of the first financial account, as shown in FIG. 4. Accordingly, the sub account 216 may be configured to receive funds from only the checking account 414. Furthermore, a user may not be able to access the funds of sub account 416 by means of a debit card or check. The sub account may be linked with the checking account from the time of its creation, and may rely on information (e.g., residential address, date of birth, full legal name, etc.) previously provided by the account holder of the checking account 414 when creating the sub account 416.

When a user wishes to schedule multiple bill payments, the reserve for bill pay process may rely on either the same secondary account or an additional, separate secondary account. As one example, a second bill reservation request associated with the first financial account may be provided by a user. Similar to the first bill reservation request, the second bill reservation request may identify a second scheduled bill event that includes a second bill amount to be paid from the first financial account via a payment processor. Funds may then be transferred equal to the second bill amount from the primary financial account to either the same secondary financial account or to a different secondary financial account, and the payment processor may be instructed to pay the second bill amount from said account. For instance, in FIG. 4, funds associated with a second bill may be transferred from the checking account 414 to the sub account 416, which may simultaneously store the funds associated with both future bill payments until their respective payment dates. In this manner, a plurality of future bill payments may be simultaneously stored by one or more secondary financial accounts.

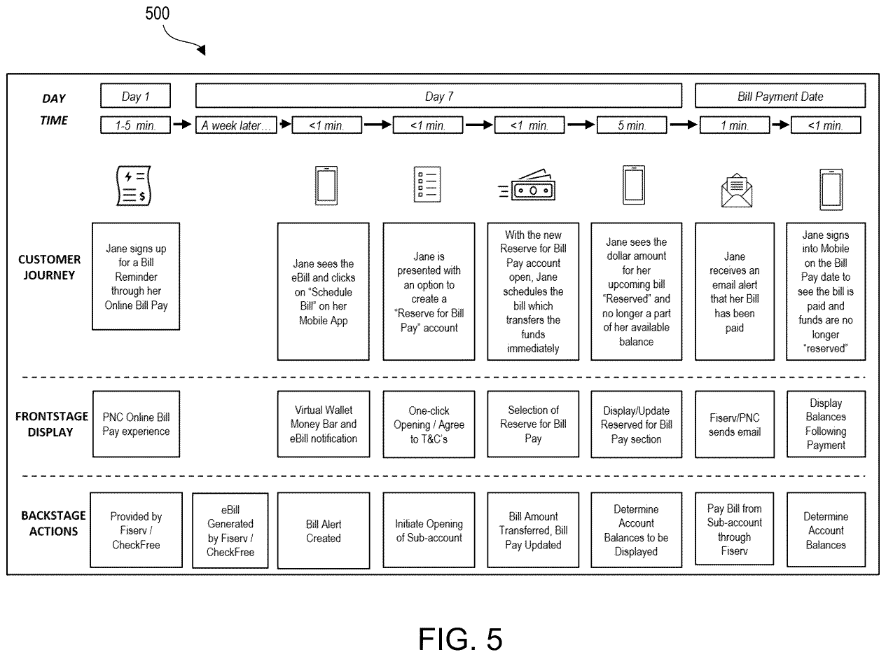

FIG. 5 depicts a timeline representation 500 of an example reserve for bill pay process, including some of the customer journey, frontstage display, and backstage actions that may be performed at various stages in the process. On the first day, a user named Jane signs up for a bill pay service through the online bill pay interface provided by her bank. As previously discussed, Jane may be required to provide various information during this step, including merchant information, her own customer account information for each merchant (e.g., an electricity bill account number), bill payment alert preferences, as well as other information. Jane's bank may then work to provide this information to a third party payment processor (Fiserv/CheckFree in this example) in order to set up the bill pay service. At a later point in time, a merchant (e.g., Internet Provider) for which Jane is a customer of issues a bill to Jane, and an electronic bill (eBill) is generated by the third party payment processor. As shown, upon receiving the electronic bill from the payment processor, Jane's mobile app associated with her bank may provide a schedule bill prompt, which allows Jane to easily schedule a bill payment. Jane may see this alert, which may be generated automatically by the bank upon receipt of the electronic bill, and take action to schedule the bill payment.

With continued reference to FIG. 5, as part of scheduling the bill payment, Jane may be prompted to submit a bill reservation request. If Jane does not already have a reserve for bill pay secondary account opened, she may be prompted to take action to open an account. For instance, Jane may be required to agree to terms and conditions of the account creation, and may need to confirm that the information associated with her checking account is still accurate, such that it can be reused for creation of the reserve for bill pay secondary account creation. The bank may then open a sub account of Jane's checking account and assign the sub account identifiers for transacting, such as a unique account number. With the new reserve for bill pay secondary account now open, Jane may then schedule the bill payment through her mobile app, and the bank may both transfer the necessary funds from Jane's checking account to the sub account and instruct the payment processor to pay the bill amount from the sub account instead of the checking account. As an alternative to requiring a manual submission of a bill reservation request for each bill payment, a user may instead preselect to have all future bill payments reserved, such that a bill reservation request is automatically generated each time a new electronic bill is received. An alert may be provided to Jane upon completion of the funds transfer between her accounts, and may take the form of an email, text, in-app alert, or a similar communication. Updated account balances, including the checking account balance available for Jane to spend and the balance of the sub account, may be determined by the bank and displayed to Jane. As will be further described, the presentation of these account balances may take specific forms that allow a user such as Jane to more-easily understand and process the state of her accounts. At this point, Jane is no longer able to simply spend the reserved funds, since they are now contained within the sub account.

On the bill payment date shown in the two rightmost columns of FIG. 5, Jane's bank may pay the funds set aside for bill payment to the payment processor and/or merchant. Jane may then receive an alert upon completion of the funds transfer, which may take the form of an email, text, in-app alert, or a similar communication. The bank may again determine and display the various account balances to Jane in her online or mobile banking account, with the funds reserved for the bill payment having been removed from the sub account. The reserve for bill pay process depicted in FIG. 5 may be repeated for each bill payment that Jane wishes to schedule.

Although the sub account is intended to prevent a user from spending reserved funds that would have otherwise remained within a checking account, it should be appreciated that options for re-transferring the reserved funds back into the checking account may be provided for a user. For instance, if an emergency arises, the user may be provided the option to cancel the scheduled bill payment and return the funds to the checking account. In this situation, the system may be configured to automatically provide a new schedule bill prompt to the user.

Generally, the backstage actions depicted in FIG. 5 may be performed on a core banking system of a financial institution, relying on computing system elements contained on that network or in communication therewith. For instance, a processor of the system may receive the bill reservation request associated with a first financial account after it is submitted by a user on a user device (e.g., cellphone, laptop computer) through an online or application interface of the banking network. The processor may then use the information associated with the bill reservation request to transfer funds from the first financial account to a second financial account. In particular, the processor may determine the amount of funds to be transferred, the identifier of the first financial account, and the identifier of the second financial account. Before the transfer, the processor may analyze whether the first account has sufficient funds for the transfer by comparing the amount of funds to be transferred with the account balance of the first financial account, which may be stored on a database in communication with, or a part of, the core banking network. The processor may then initiate the transfer process and record the details of the transfer transaction in the network databases. In order to ensure that the payment is taken from the second financial account, the processor may communicate with a payment processor network, such as by providing the identifier of the second financial account to the payment processor network, which may be communicated along with additional information associated with the scheduled bill payment.

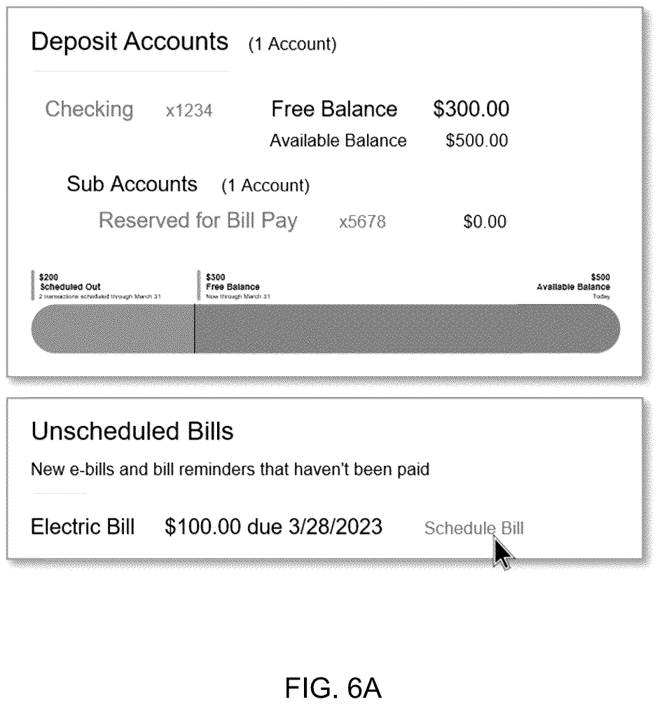

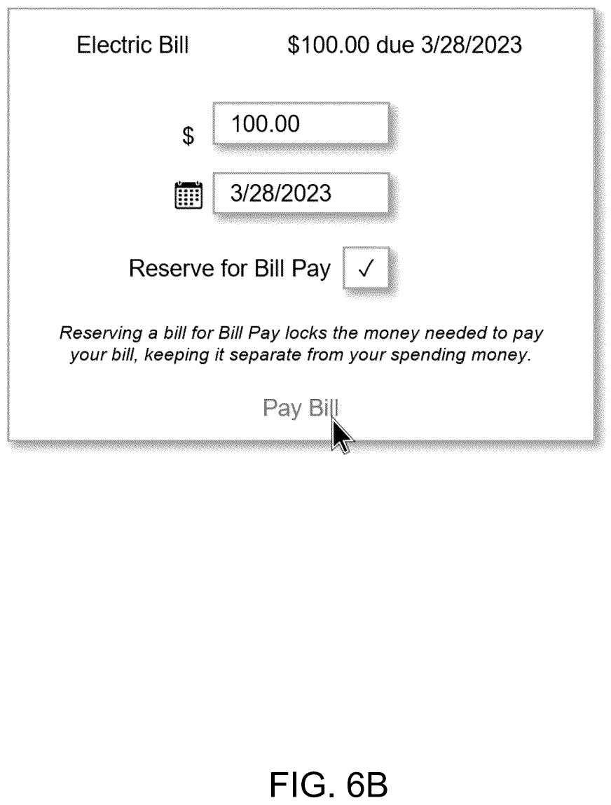

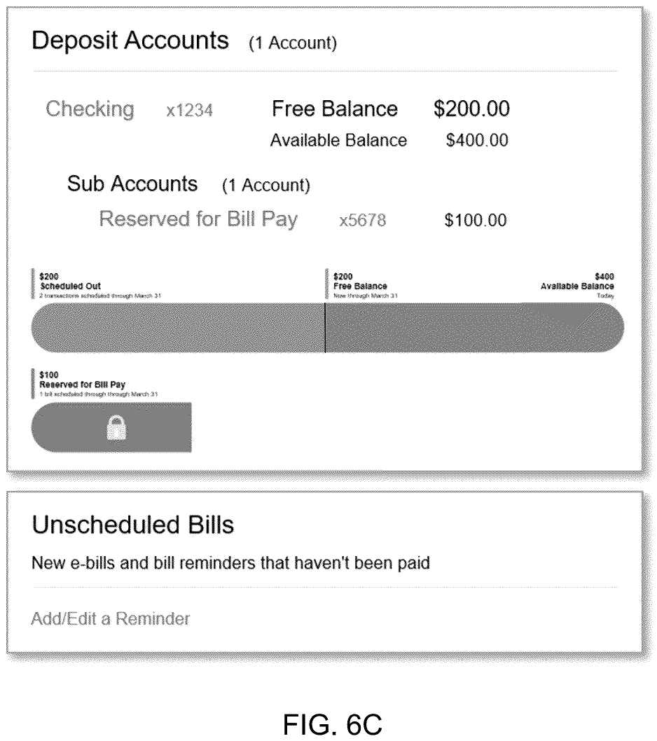

FIGS. 6A-6C depict graphical user interfaces (GUIs) that may be provided to a user device as part of the reserve for bill pay processes described herein. These depictions serve as examples of how information associated with a sub account may be displayed to an account holder. The GUI of FIG. 6A depicts a checking account which includes a visual indicator in the form of a horizontally oriented, oblong bar that is subdivided into a “scheduled out” section and a “free balance” section, which form the total “available balance” of the “x1234” checking account. Separate from this visual indicator, a “x5678” reserve for bill pay sub account is indicated as having no funds and a zero balance. Beyond the account balance information provided, a first part of a schedule bill prompt is also provided as part of the GUI. An example electric bill is shown with information that includes the identity of the bill, the amount of the bill, and the bill date. A user is prompted to “schedule bill,” such that the bill payment will be directly paid from an online account, rather than via a card payment or check.

FIG. 6B depicts a second part of the schedule bill prompt that may be displayed after a user selects the “schedule bill” option in FIG. 6A. The schedule bill prompt may prefill the bill amount and payment date fields, which may be adjustable. A reserve for bill pay option may be provided to a user, prompting them to submit a bill reservation request and informing them of the purpose of the reservation process, such that “reserving a bill for Bill Pay locks the money needed to pay your bill, keeping it separate from your spending money.” Alternative reserve for bill pay options may also be provided as part of the GUI, such as a selection of the amount of funds to be reserved at this time.

FIG. 6C depicts an updated version of the GUI provided in FIG. 6A after a user has made a bill reservation request and a transfer of the reserved funds has been completed. As can be seen, the checking account still includes a visual indicator in the form of a horizontally oriented, oblong bar that is subdivided into a “scheduled out” section and a “free balance” section, which form the total “available balance” of the “x1234” checking account. Additionally, a reserved for bill pay bar has been added as part of the visual indicator, with the length and area of the reserved for bill pay bar relative to the “scheduled out” and “free balance” bar sections being proportional to the amount of funds in the reserved for bill pay account relative to the “scheduled out” and “free balance” funds. In this manner, a user viewing the GUI may easily determine the relative amount of their checking account that has already been reserved for future bill payments, and the amount that is available to spend on immediate purchases.

As can be seen, the reserve for bill pay bar of the visual indicator includes a lock symbol that indicates to a user that these funds are reserved and not available to be spent. Alternative symbols, word text, images, or colors may be associated with the reserve for bill pay bar to indicate that the associated funds are reserved for bill payment. The reserve for bill pay bar also includes associated text in close proximity that identifies the account balance and the funds within the bar are “Reserved for Bill Pay,” and also provides an indication of how many upcoming bills are scheduled by stating “1 bill scheduled through March 31.” The checking account bar may include similar information in a text form, as shown. Additional account balances and information may also be provided as part of the depicted GUI. Furthermore, other graphical representations beyond the depicted proportional bar may be employed, including alternative shape constructions or methods of representing the proportional balances and reserved funds.

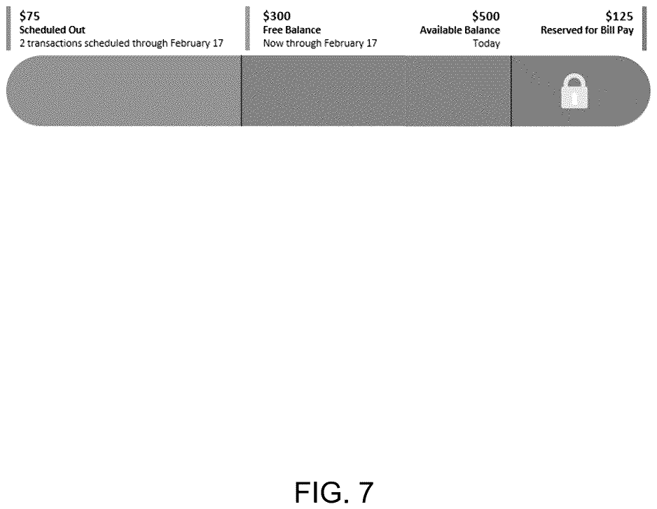

FIG. 7 depicts an alternative form for visual indicator of the graphical user interface depicted in FIG. 6C. As shown, the visual indicator is now formed of a single bar with sections corresponding to the account balance of a checking account (“Scheduled Out” and “Free Balance”) and a sub account (“Reserved for Bill Pay”) of the checking account. By providing the visual indicator as a single bar, a user may easily evaluate the total funds included in both the primary checking account and the related sub account, as well as the amount that is available to be spent as part of the “Free Balance.” Although this depiction is not drawn to scale, it should be appreciated that the various lengths and areas of each of the sections of the visual indicator may be proportional to the respective account balances of those sections.

The example GUIs of FIGS. 6A-7 may be generated automatically using the core banking system of a financial institution and then provided to a user device. For instance, using processors associated with a core banking system, data relating to the account balances of the checking account and the reserve for bill pay accounts may be acquired from databases housing this information. The core banking system may continuously update the stored account balances associated with each account following each transaction, including the transfer of reserved funds from the primary account to the secondary account and the eventual payment of those funds from that account. The processors of the core banking system may generate the GUIs for display based on the account balances of each financial account, the information received regarding the bill payment, other transactional information associated with each account, as well as other information.

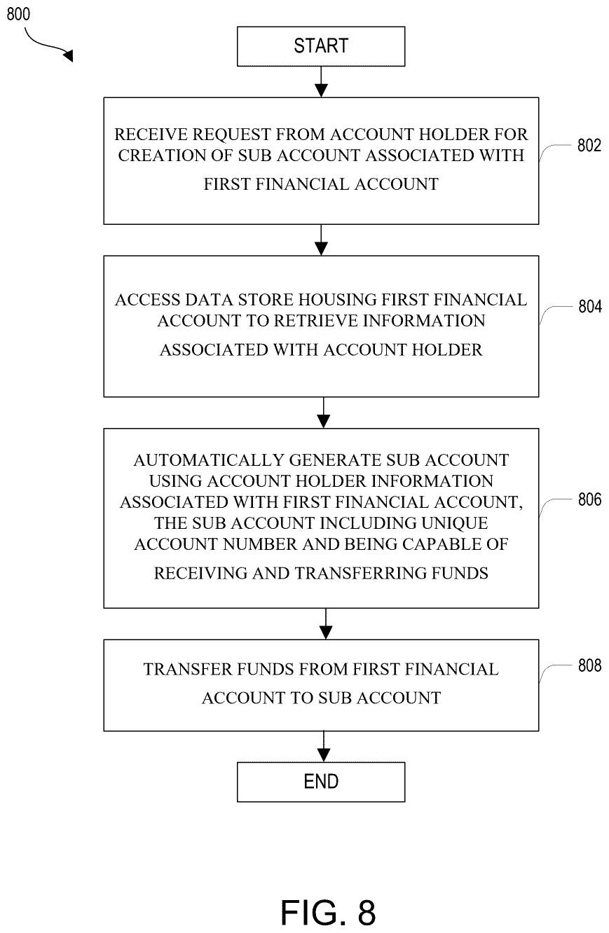

In accordance with the systems and methods described herein, FIG. 8 depicts a flowchart of a method 800 for reserving funds for future payment. At 802, a request from an account holder for the creation of a sub account associated with a first financial account may be received. At 804, a data store housing the first financial account may be accessed to retrieve information associated with the account holder. At 806, a sub account may be automatically generated using the account holder information associated with the first financial account. The sub account may include a unique account number and may be capable of receiving and transferring funds. At 808, funds may be transferred from the first financial account to the sub account.

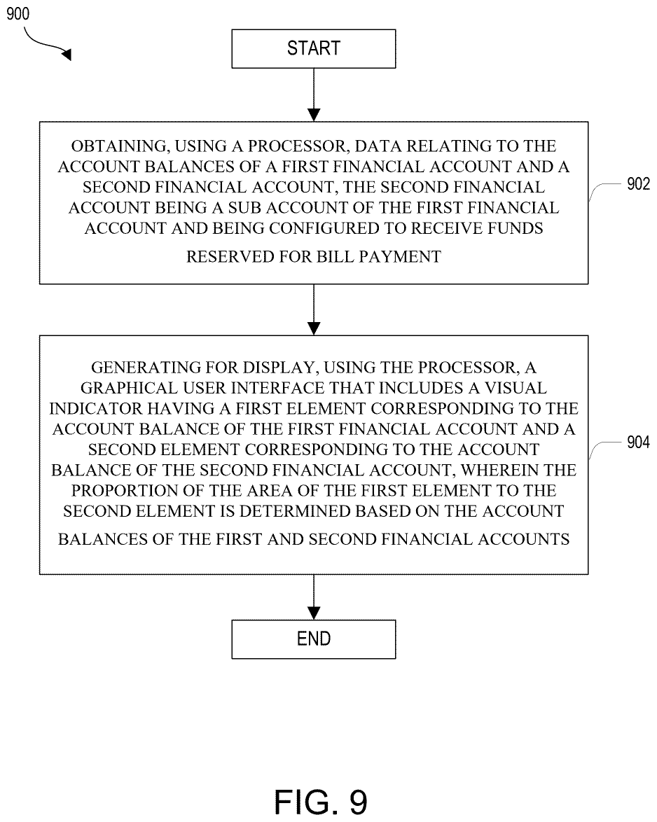

In accordance with the systems and methods described herein, FIG. 9 depicts a method 900 for generating a graphical representation of financial accounts that are administered by an entity. At 902, data relating to the account balances of a first financial account and a second financial account may be obtained using a processor. The second financial account may be a sub account of the first financial account and may be configured to receive funds reserved for bill payment. At 904, a graphical user interface (GUI) that includes a visual indicator having a first element corresponding to the account balance of the first financial account and a second element corresponding to the account balance of the second financial account may be generated for display using the processor. The GUI may have various properties to assist in providing specific information to a user. For instance, the proportion of the area of the first element to the second element may be determined based on the account balances of the first and second financial accounts.

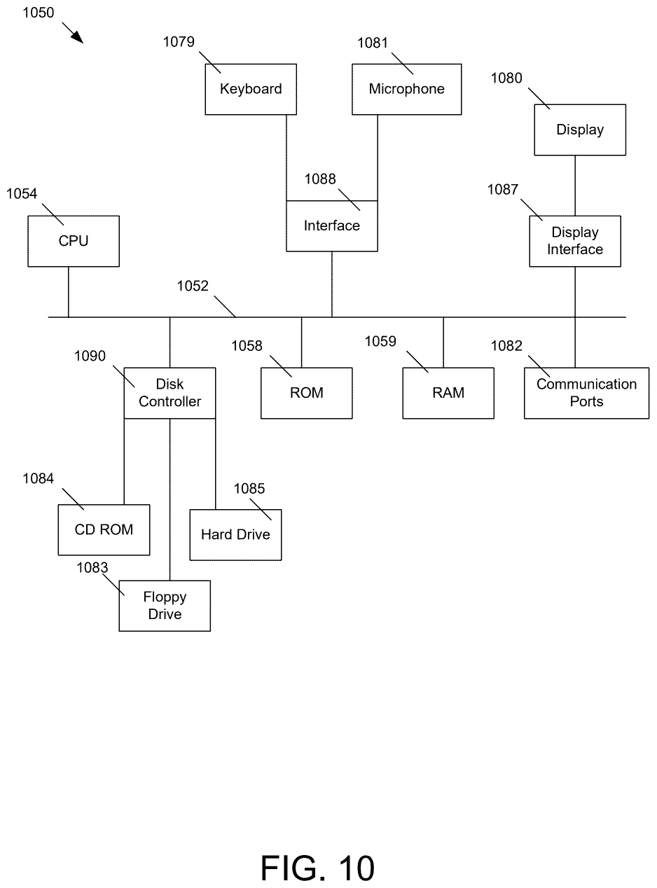

FIG. 10 shows a block diagram of exemplary hardware for a standalone computer architecture 1050 that may be used to include and/or implement the program instructions of the various aspects of the present disclosure. A bus 1052 may serve as the information highway interconnecting the other illustrated components of the hardware. A processing system 1054 labeled CPU (central processing unit) (e.g., one or more computer processors at a given computer or at multiple computers), may perform calculations and logic operations required to execute a program. A non-transitory processor-readable storage medium, such as read only memory (ROM) 1058 and random access memory (RAM) 1059, may be in communication with the processing system 1054 and may include one or more programming instructions for preventing unauthorized access to a computing system. Optionally, program instructions may be stored on a non-transitory computer-readable storage medium such as a magnetic disk, optical disk, recordable memory device, flash memory, or other physical storage medium.

In FIG. 10, computer readable memories 1007, 1030, 1058, 1059 or data stores 1008, 1032, 1083, 1084, 1088 may include one or more data structures for storing and associating various data used in the example systems. For example, a data structure stored in any of the aforementioned locations may be used to store data from XML files, initial parameters, and/or data for other variables described herein. A disk controller 1090 interfaces one or more optional disk drives to the system bus 1052. These disk drives may be external or internal floppy disk drives such as 1083, external or internal CD-ROM, CD-R, CD-RW or DVD drives such as 1084, or external or internal hard drives 1085. As indicated previously, these various disk drives and disk controllers are optional devices. Each of the element managers, real-time data buffer, conveyors, file input processor, database index shared access memory loader, reference data buffer and data managers may include a software application stored in one or more of the disk drives connected to the disk controller 1090, the ROM 1058 and/or the RAM 1059. The processor 1054 may access one or more components as required.

A display interface 1087 may permit information from the bus 1052 to be displayed on a display 1080 in audio, graphic, or alphanumeric format. Communication with external devices may optionally occur using various communication ports 1082. In addition to these computer-type components, the hardware may also include data input devices, such as a keyboard 1079, or other input device 1081, such as a microphone, remote control, pointer, mouse and/or joystick.

Generally, the methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein and may be provided in any suitable language such as C, C++, JAVA, for example, or any other suitable programming language. Other implementations may also be used, however, such as firmware or even appropriately designed hardware configured to carry out the methods and systems described herein.

The present disclosure has been presented for purposes of illustration. It is not exhaustive and is not limited to precise forms or embodiments disclosed. Modifications and adaptations of the embodiments will be apparent from consideration of the specification and practice of the disclosed embodiments. Moreover, while illustrative embodiments have been described herein, the scope includes any and all embodiments having equivalent elements, modifications, omissions, combinations (e.g., of aspects across various embodiments), adaptations and/or alterations based on the present disclosure. The elements in the claims are to be interpreted broadly based on the language employed in the claims and not limited to examples described in the present specification or during the prosecution of the application, which examples are to be construed as nonexclusive. Further, the steps of the disclosed methods can be modified in any manner, including reordering steps and/or inserting or deleting steps.

The features and advantages of the disclosure are apparent from the detailed specification, and thus, it is intended that the appended claims cover all systems and methods falling within the true spirit and scope of the disclosure. As used herein, the indefinite articles “a” and “an” mean “one or more.” Similarly, the use of a plural term does not necessarily denote a plurality unless it is unambiguous in the given context. Words such as “and” or “or” mean “and/or” unless specifically directed otherwise. Further, since numerous modifications and variations will readily occur from studying the present disclosure, it is not desired to limit the disclosure to the exact construction and operation illustrated and described, and accordingly, all suitable modifications and equivalents may be resorted to, falling within the scope of the disclosure.

In general, it will be apparent to one of ordinary skill in the art that some of the embodiments as described hereinabove may be implemented in many different embodiments of software, firmware, and/or hardware. For example, the embodiments described hereinabove may be implemented in computer software using any suitable computer software language. Such software may be stored on any type of suitable computer-readable medium or media such as, for example, a magnetic or optical storage medium. Thus, the operation and behavior of the embodiments are described without specific reference to the actual software code or specialized hardware components. The absence of such specific references is feasible because it is clearly understood that artisans of ordinary skill would be able to design software and control hardware to implement the embodiments of the present invention based on the description herein with only a reasonable effort and without undue experimentation.

Moreover, the processes associated with the present embodiments may be executed by programmable equipment, such as computers. Software that may cause programmable equipment to execute the processes may be stored in any storage device, such as, for example, a computer system (nonvolatile) memory, an optical disk, magnetic tape, or magnetic disk. Furthermore, some of the processes may be programmed when the computer system is manufactured or via a computer-readable medium. Such a medium may include any of the forms listed above with respect to storage devices as well as others. The computing systems described herein can be generally controlled and coordinated by operating system software, such as iOS, Android, Blackberry, Chrome OS, Windows XP, Windows Vista, Windows 7, Windows 8, Windows Server, Windows CE, Unix, Linux, SunOS, Solaris, Vx Works, or other compatible operating systems. In other embodiments, the computing device can be controlled by a proprietary operating system. Operating systems can control and schedule computer processes for execution, perform memory management, provide file systems, networking, I/O services, and provide a user interface functionality, such as a graphical user interface (“GUI”), among other things.

Furthermore, although aspects of the disclosed embodiments may be associated with data stored in memory and other tangible computer-readable storage mediums, one skilled in the art will appreciate that these aspects can also be stored on and executed from many types of tangible computer-readable media, such as secondary storage devices, like hard disks, floppy disks, or CD-ROM, or other forms of RAM or ROM. Accordingly, the disclosed embodiments are not limited to the above described examples, but instead are defined by the appended claims in light of their full scope of equivalents.

While the disclosure has been described in detail and with reference to specific embodiments thereof, it will be apparent to one skilled in the art that various changes and modifications can be made therein without departing from the spirit of the embodiments. Thus, it is intended that the present disclosure cover the modifications and variations of this disclosure provided they come within the scope of the appended claims and their equivalents.

It is claimed:

1. A banking system comprising one or more processors coupled to at least one data store that stores instructions, which when loaded into at least one memory cause the one or more processors to perform operations, including:
receiving a request from an account holder for the creation of a sub account associated with a first financial account;
accessing a data store housing the first financial account to retrieve information associated with the account holder,
automatically generating a sub account using the account holder information associated with the first financial account, the sub account including a unique account number and being capable of receiving and transferring funds; and
transferring funds from the first financial account to the sub account.

2. The banking system of claim 1, further comprising:
generating for display, using the processors, a graphical user interface depicting the account balances of both the first financial account and the sub account.

3. The banking system of claim 1, wherein the graphical user interface includes a visual indicator having a fixed shape formed of a first segment and second segment, the length of first segment being proportional to the account balance of the first financial account and the second segment being proportional to the account balance of the sub account.

4. The banking system of claim 1, wherein the first financial account is a checking account.

5. The banking system of claim 1, wherein the first financial account is distinct from the sub account such that a checking transaction or withdrawal associated with the first financial account cannot directly access funds held within the sub account.

6. The banking system of claim 1, further comprising:
automatically retiring the sub account if the funds are subsequently transferred out of the sub account.

7. The banking system of claim 1, further comprising:
providing an alert to an account holder of the first and second financial accounts upon completion of the funds transfer from the first financial account to the sub account.

8. The banking system of claim 1, further comprising:
providing an account creation prompt to the account holder of the first financial account.

9. The banking system of claim 1, further comprising:
receiving a bill reservation request associated with a first financial account, the bill reservation request identifying a scheduled bill event that includes a bill amount to be paid from the first financial account via a payment processor, wherein funds equal to the bill amount are transferred from the first account to the sub account following receipt of the bill reservation request; and
instructing the payment processor to transfer the bill amount identified in the bill reservation request from the sub account instead of the first financial account.

10. The banking system of claim 9, wherein instructing the payment processor includes providing an identifier associated with the sub account to the payment processor.

11. The banking system of claim 9, further comprising:
transferring funds equal to the bill amount, using the processors, from the sub account to the payment processor upon receiving a transfer request from the payment processor.

12. The banking system of claim 11, further comprising:
providing an alert to an account holder of the first financial account upon completion of the funds transfer from the sub account to the payment processor.

13. The banking system of claim 9, further comprising:
receiving an electronic bill from the payment processor; and
providing a schedule bill prompt to an account holder of the first financial account based on the electronic bill, wherein the schedule bill prompt enables the account holder to submit the bill reservation request.

14. The banking system of claim 9, further comprising:
receiving a second bill reservation request associated with the first financial account, the second bill reservation request identifying a second scheduled bill event that includes a second bill amount to be paid from the first financial account via the payment processor;
transferring funds equal to the second bill amount identified in the second bill reservation request from the first financial account to the sub account; and
instructing the payment processor to transfer the second bill amount identified in the second bill reservation request from the sub account instead of the first financial account.

15. A computer-assisted method for generating a graphical representation of financial accounts that are administered by an entity, the method comprising:
obtaining, using a processor, data relating to the account balances of a first financial account and a second financial account, the second financial account being a sub account of the first financial account and being configured to receive funds reserved for bill payment; and
generating for display, using the processor, a graphical user interface that includes a visual indicator having a first element corresponding to the account balance of the first financial account and a second element corresponding to the account balance of the second financial account, wherein the proportion of the area of the first element to the second element is determined based on the account balances of the first and second financial accounts.

16. The computer-assisted method of claim 15, wherein the visual indicator includes a symbol, word text, or image associated with the second shape that indicates that the funds within the second financial account are reserved for bill payment.

17. The computer-assisted method of claim 15, wherein the first financial account is distinct from the second financial account such that a checking transaction or withdrawal associated with the first financial account cannot directly access funds held within the second financial account.

18. The computer-assisted method of claim 15, wherein the visual indicator includes word text identifying the number of bills scheduled to be paid from the second financial account.

19. The computer-assisted method of claim 15, wherein the first element, the second element, or the combination of the first element and the second element form a horizontally oriented, oblong shape.

20. A system for reserving funds in a financial account for future bill payment, the system comprising:
means for receiving a request from an account holder for the creation of a sub account associated with a first financial account;
means for accessing a data store housing the first financial account to retrieve information associated with the account holder;
means for automatically generating a sub account using the account holder information associated with the first financial account, the sub account including a unique account number and being capable of receiving and transferring funds;
means for transferring funds from the first financial account to the sub account.
